(19) United States
(12) Patent Application Publication
(10) Pub. No.: US 2014/0136234 A1
(43) Pub. Date: May 15, 2014

(54) METHOD AND APPARATUS FOR MAPPING PATIENT CREATED DATA FROM EXTERNAL SYSTEMS TO ELECTRONIC HEALTH RECORDS

(71) Applicant: David WEINSTEIN, Danville, CA (US)

(72) Inventor: David WEINSTEIN, Danville, CA (US)

(21) Appl. No.: 13/895,909

(22) Filed: May 16, 2013

Related U.S. Application Data
(60) Provisional application No. 61/724,600, filed on Nov. 9, 2012.

(51) Int. Cl. G06F 19/00

(52) U.S. Cl. CPC G06F 19/322; G06F 19/3418
USPC 705/3

(57) ABSTRACT

In an embodiment of the invention, a patient's mobile phone number and a patient matching or ID creation algorithm that requires the patient's mobile phone number or any derivative or transformation thereof is used as a mapping method to map patient created data related to a patient's health into the correct patient records in EHRs accurately and cost effectively.

### CROSS REFERENCE TO RELATED APPLICATIONS

This application claims priority to U.S. provisional patent application Ser. No. 61/724,600, filed Nov. 9, 2012, which application is incorporated herein in its entirety by this reference thereto.

### BACKGROUND OF THE INVENTION

1. Technical Field

The invention relates to health records. More particularly, the invention relates to a method and apparatus for mapping patient created data from external systems to electronic health records.

2. Description of the Background Art

In recent years, a plethora of devices and software applications have come to market that have the capacity to send patient created data and other data to electronic health records, such data emanating from a variety of remote sources including, but not limited to, patients' mobile (aka “smart”) phones, web sites, web-based computer programs used by patients, and devices attached to or communicating with patients' bodies. However, there is not an efficient method for mapping these patient created data in an automated fashion to patient electronic health records, charts, folders, or other records, and the software that houses, accesses, reads, writes, and otherwise manages these records used by persons or entities involved in some aspect of managing, treating, or administering any aspect of a patient's health, collectively referred to as “EHRs.” Therefore, the technical and business problem that needs to be solved is “How can these data be mapped accurately and efficiently in an automated fashion to the correct patient records in one or more EHRs that can be accessed and used by patients' health care providers, administrators or other parties involved in some aspect of a patient's health care?”

By way of illustration, an entity called PositiveID Corporation is developing or has developed a product called Iglucose™ that purports to provide a:
“breakthrough in diabetes management by automatically and wirelessly communicating blood glucose readings and creating logbooks and trend reports without the need for a mobile phone or manual entry. At the user's consent, the data stored in the Iglucose diabetes management portal can be shared automatically with family members, caregivers and healthcare professionals via text message, email or fax.”

Significantly, “directly into the patient's electronic health record” is omitted from the description above. The silence around how the blood glucose data from the Iglucose device actually gets into patients' electronic health records used by caregivers or others is deafening. The implication is that the information is sent to one or more data users via text message, email, or fax. There are several suboptimal qualities to using these transport methods. First, text messaging and most email services use unencrypted transport mechanisms to carry data, thus making substantial permissions from, and disclosures to, the patient necessary for these communication channels if they are to be compliant with the Health Insurance Portability and Accountability Act of 1996 as amended from time to time (“HIPAA”). Second, all three of these transport methods require human intervention by the data users to make sure that these data are accurately mapped to the correct patient electronic health records. It is also worth noting that blood glucose levels are an example of lab values, a critical information set that is used in many aspects of managing a patient's health care.

In spite of these challenges, market forces in the United States, including those stemming from the passage of the Patient Protection and Affordable Care Act (“PPACA”) of 2010, have created the need for accountable care organizations, i.e. groups that strive to coordinate care for patients across a myriad of business entities and, in addition, have financial incentives to change both [i] patient behaviors for the better and [ii] track patient data much more frequently than has been done in the past. Yet, there does not exist an efficient, largely automated process to ingest patient created data and map it to the correct patient records in EHRs.

Currently, in many countries outside the United States, health care is delivered using a single payer system, where each patient has a unique identification (or “ID”) number that can be used to map patient created data to the correct patient record in EHRs. Even in certain countries where there may not be a single payer health care system, the cultures and traditions of these countries may permit the issuance of unique identifiers (numeric or alphanumeric) for use in delivering health care services or for other purposes. However, residents of the United States have neither a single payer health care system spanning most or all patients, such that a unique ID number can be generated for the patient, nor do they have government issued national ID numbers. Therefore, the option of using such an ID as a method to map patient created data to EHRs is not available.

One might suggest that a patient's Social Security number is a unique ID number that would fulfill this need for patients in the United States. However, one's Social Security number has practical challenges to being used as a unique identifier for mapping patient created data to EHRs. First, one's Social Security number is considered very sensitive and is already used extensively for tracking financial accounts, computing credit scores, and managing government benefits and entitlements; one's Social Security number is also considered a key element of successful identity theft, which can be a nightmare for those individuals whose identities have been stolen. Therefore, patients are reluctant to allow their Social Security numbers to be used for this or other additional purposes. Illustrating concerns about data privacy, more than half of mobile application users have uninstalled or avoided certain applications due to concerns about the way personal information is shared or collected by the application, according to a nationally representative telephone survey conducted by the Pew Research Center's Internet & American Life Project. Further, third party software and services vendors that traffic in patient health care data might view the safeguarding of Social Security numbers as a significant additional business risk and therefore be reluctant to adopt the Social Security number as an ID for the purposes of mapping data to patient records in EHRs. For these reasons and perhaps others, there would likely be widespread resistance to using Social Security numbers as such a mapping ID.

Insurance benefit IDs are also impractical to be used for mapping patient created data to EHRs. These IDs often change every year or two as patients move from one insurance plan to another. In addition, a significant percentage of insured patients have a medical benefits manager that is different from their pharmacy benefits manager, giving them two health insurance IDs at the same time. Some Medicaid patients also have Medicare benefits and these patients, sometimes referred to as “dual eligibles”, are also often given special flexibility to change privately administered Medicare plans as often as every month. Furthermore, notwithstanding the passage of PPACA, there remain many uninsured patients who, as a consequence of being uninsured, do not have an insurance ID. Finally, insurance IDs are not standardized across insurance administrators. Some IDs are numeric, some are alpha numeric, and some use a combination of patient IDs (a.k.a. Member IDs) and person codes within a family, whereas others do not. For all these reasons, private insurance ID numbers are not practical for this purpose.

Therefore, there is a great need in the field of health care for a cost effective, efficient, and automated method to map patient created health data to the correct records in EHRs.

### DESCRIPTION OF RELATED ART

There are methods today used to map a patient's created data into the correct records in a data user's EHR software. By way of illustration, three methods include (1) Provider Direct to Record, (2) Patient Direct to Record, and (3) Multiple Field Matching (described below).

### Provider Direct to Record

In past years, a physician might have pulled a patient's paper based record from a file cabinet, met with the patient in person, written down data from the patient meeting, and filed the paper record back to the file cabinet. Today, many physicians have adopted EHR software. These physicians continue to enter data directly into the patient's electronic record during face-to-face patient meetings, phone calls, etc., often using a computer keyboard.

### Patient Direct to Record

As the crisis in health care, both financially and quality of life related, continues to grow in the United States, there has also been an effort made to gather data from patients when the patient is not in direct communication with the physician, i.e. remotely. One method that exists today allows the patient to logon directly to the physician's EHR software with a user name and password and then type in health related data. The patient is authenticated and identified through specific methods setup through the physician's software often informed by the physician's policies and procedures. However, the mapping methods setup in this instance are unique to the specific data user's EHR. If the same patient wanted to transmit the same patient created data to other data users, he would have to establish specific communications methods with each data user's EHR.

### Multiple Field Matching

Some software developers and service providers have attempted to use multiple field matching to determine a patient match when exchanging data. One of the more common approaches to match non patient created data is to use the fields of (i) Patient First Name, (ii) Patient Last Name, (iii) Date of Birth, and (iv) Gender. This approach is often successful, but has shortcomings including errors or failed matching that occur when one or more of the fields are misspelled, incorrect, or missing. While some of these algorithms might include or leverage the patient's mobile phone number as one of the matching fields, none of them depend upon it as a required field to execute a patient match. These shortcomings are exacerbated when patients are tasked with the data entry of these fields and the data entry of these fields is distributed and decentralized over millions of patients as opposed to data entry savvy organizations with strict processes and procedures around quality control. The likelihood of error also increases when four fields must be correct instead of just one. Furthermore, these four fields must be consistently recorded across all the data users' systems to assure the data received are accurately matched to the correct patient record.

### Uses of Phone Numbers as Identifiers Outside of Health Care

The phone number of an individual or household is commonly used in consumer loyalty programs to create consumer profiles and, as compensation, provide consumers with product or service discounts. For example, Safeway supermarkets allow shoppers to enter their phone numbers as identifiers when checking out to earn discounts for the shopper and allow proper data capture and household matching for Safeway. However, these programs are concerned about household profiles, not individual profiles. Safeway is content to develop household level profiles and having some strong confidence about a one-to-one relationship between a phone number ID and an individual is not the predominant driver of the business need. Thus, it quite common for a phone number ID in these settings to map to multiple individuals. Second, these programs allow the use of either landline phone numbers or mobile phone numbers as identifiers, reinforcing the notion that the phone number is being used as a household mapping tool, not as an individual mapping tool

### SUMMARY OF THE INVENTION

In some embodiments, the invention comprises computer implemented methods and systems to use a patient's mobile phone number or derivative or transformation thereof as a necessary part of a unique patient identifier. Embodiments of the invention represent a novel method for efficiently mapping patient created data in an automated fashion to the correct patient records in EHRs.

In some embodiments, the invention comprises computer automated methods and systems using a patient's mobile phone number and a patient matching or ID creation algorithm that requires the patient's mobile phone number or any derivative or transformation thereof, as a mapping method to map patient created health data to the correct patient records in EHRs both accurately and cost effectively.

### BRIEF DESCRIPTION OF THE DRAWINGS

FIG. 1 is a flow diagram that illustrates an example of how the patient submits a mobile phone number to both the data origination device and authorized data users according to the invention;

FIG. 2 is a block schematic diagram that illustrates an example of patient created data being inputted into the data origination device or being read from the patient's body by the data origination device according to the invention;

FIG. 3 is a block schematic diagram that illustrates an example of how a message containing the patient created data is created using the patient's mobile phone number according to the invention;

FIG. 4 is a block schematic diagram that illustrates an example of some of the pathways the message containing the patient created data might take as it is routed from the data origination device to the EHRs of the data users according to the invention;

FIG. 5 is a block schematic diagram that illustrates an example of how the patient's mobile phone number may be used to identify the correct patient record in the data user's EHR and as a result the patient created data is written to the correct patient record according to the invention; and

FIG. 6 is a block schematic diagram that depicts a machine in the exemplary form of a computer system within which a set of instructions for causing the machine to perform any of the herein disclosed methodologies may be executed.

### DETAILED DESCRIPTION OF THE INVENTION

Embodiments of the invention relate to the field of health care information exchange. More specifically, embodiments of the invention comprise computer implemented methods and systems to map a patient's health and other data entered into, or read by, an external system, such as a mobile computer, other computer, mobile phone, or medical device efficiently and accurately, and to transmit such data to the correct patient record in electronic health record software used by Covered Entities, Business Associates and Business Associate Subcontractors, as defined by the Health Insurance Portability and Accountability Act of 1996 (“HIPAA”), as it is amended from time to time. These entities include, but are not limited to, physicians, pharmacists, hospitals, pharmacy benefit managers, disease managers, employers, payers, administrators, software vendors, data clearinghouses and service providers. Collectively, in this document, these entities and other relevant stakeholders in a patient's health care are referred to as “data users”.

### DEFINITIONS

As used herein, the term “patient created data” means data that is conveyed by a patient or patient's designee into a computer or other data entry device or computed or read from a patient's body or patient actions by a computer or other device capable of reading such data.

As used herein, the term “EHR” or “Electronic Health Record” shall generally mean patient electronic health records, charts, folders or other records and the software that stores, accesses, reads, writes and otherwise manages these records used by persons or entities involved in some aspect of managing, treating, or administering any aspect of a patient's health used by persons or entities involved in some aspect of managing, treating, or administering any aspect of a patient's health.

As used herein the term “mapping” shall generally mean the process by which something, such as data, is taken from a state where it is ungrouped or unorganized or unassociated with other data and then grouped and organized and associated to other data. One embodiment of mapping is the process of taking an electronic message containing data about a patient's health and grouping it with other data about that same patient, data that resides in one or more EHRs.

As used herein, the term “health data” or “data” shall mean information about a person's health or a person's identity that is used for health care provision, delivery, management, research, operations, finance, or other uses. Non-limiting examples of health data include the patient's heart rate or blood glucose level.

As used herein, the term “computer” generally refers to a machine, apparatus, or device that is capable of accepting and performing logic operations derived from software code.

The term “software,” “software code,” or “computer software” refers to any set of instructions operable to cause a computer to perform an operation. Software code may be operated on by a rules engine or processor. Thus, the methods and systems of the invention may be performed by a computer based on instructions received by computer software.

The term “data origination device” as used herein is a type of computer which is generally carried by a person, operated by a person, attached to a person, or otherwise interacting with a person. Non-limiting examples of data origination devices may include personal computers (PCs), workstations, laptops, tablet PCs including the iPad®, cell phones, smart phones, including iPhones® and Android® phones, medical devices such as Iglucose™ (developed by PositiveID Corporation), glucometers, computer driven wristwatches, or generally any device capable of running computer software and displaying information to a user. In some preferred embodiments, a data origination device is capable of sending patient health data over a data network.

As used herein the term “data network” shall mean an infrastructure capable of connecting one or more computers, either using wires or wirelessly, allowing them to transmit and receive data. Non-limiting examples of data networks may include the Internet and intranets including, but not limited to, Wi-Fi networks or wireless cellular networks, e.g. 3G and 4G LTE. To the extent protected health information as defined by HIPAA is being transmitted, these networks may be capable of transmitting, routing, and receiving messages in a secure and/or encrypted manner.

As used herein, the term “database” is an organized collection of data. The data in a database are typically organized to model relevant aspects of reality, for example the organization of information about a patient's health, in a way that supports processes requiring this information. One example of a database is a digital collection of patient information, such as patient health records relating to a user or patient. For the purposes of the disclosure herein, a database may be stored on a server or other computer and accessed through a data network, e.g. the database is in the cloud, or alternatively in some embodiments the database may be stored on a directly accessible computer itself, i.e. local storage.

The term “data users” has been previously defined in this document.

### DISCUSSION

What is needed to solve the technical problem of mapping patient created data to the correct patient records in EHRs is a unique identifier for each patient, i.e. a one-to-one mapping, that is (1) stable over time, and (2) does not have the financial and/or identity theft sensitivity of the Social Security number so as to render its adoption impractical, and (3) is unique, such that it cannot be confused with the identity of another patient, i.e. there is no likelihood of a collision between the health related information of one patient with that of another patient.

In some embodiments, the invention comprises computer implemented methods and systems using (i) a patient's mobile phone number, (ii) a patient matching or ID creation algorithm that requires the patient's mobile phone number, or (iii) any derivative or transformation thereof as a mapping mechanism to map patient created data into the correct patient record in an appropriate EHR accurately and cost effectively.

An embodiment of (i) above may be, for example, the use of the patient's mobile phone number alone to match the incoming message containing data about a unique patient with the electronic health record of that same patient. Thus, an identifier in this case for a particular patient having a mobile phone number (999) 555-1212 might be 9995551212.

An embodiment of (ii) above may be, for example, the use of the combination of a patient's phone number with the patient's date of birth to match the incoming message for a unique patient with the electronic health record of that same patient sufficiently. Thus, an example of an identifier in this case for a particular patient might be 999555121201011950, which would represent the patient's mobile phone number concatenated with his date of birth, i.e. Jan. 1, 1950.

An embodiment of (iii) above may be, for example, the use of a patient's mobile phone number transformed into a string of characters that are then used by the EHR software to map the message to the correct patient record. Thus, an identifier in this case for a particular patient might be IIIEEEABAB which would represent the patient's mobile phone number converted to letters based upon their position in the alphabet.

The patient's mobile phone number has the following characteristics that support its practical use as a solution to this technical problem:

1. It is almost always a one-to-one mapping, i.e. the mobile phone number maps to a unique patient.
2. Mobile phones are becoming very common among American adults. According to a recent survey, 88% of adult Americans have a mobile phone.
3. Mobile phone numbers are portable when a patient changes his mobile phone provider or moves out of town. Given the cost involved in updating the directory's of all of one's personal and business contacts, and given a choice, people keep their mobile phone numbers constant for many years, if not a lifetime, even if they move geographically.
4. For patients using so called smartphones, healthcare data collection applications that run on smartphones can easily capture the patient's mobile phone number from the smartphone in an automated fashion, saving a step for the patient.
5. Data gathering or data input devices or software that do not require the use of a mobile phone may nevertheless use the patient's mobile phone number as the basis for accurate and efficient mapping of patient created data to the patient's EHRs.

The use of one's mobile phone number as a mapping method does not carry the stigma and risk of using one's Social Security number and is much more stable over time than an insurance ID number. While it is surely the case that many minors, especially young children, do not have mobile phone numbers, they also represent the one segment of the population for which this business problem is insignificant. It is insignificant among minors generally because most members of this age group do not have a meaningful need to provide patient created data to data users from remote locations.

The mobile phone number is used by a variety of data origination devices to facilitate the communication of patient created data to data users. These settings include, but are not limited to, mobile phones, mobile computers, computers, medical devices, and other devices.

Under United States guidelines for the meaningful use of Electronic Health Record technology, a certified Electronic Health Record system must be able to receive documents formatted in either the Continuity of Care Record (“CCR”) or the Continuity of Care Document (“CCD”) standard and display them in a human-readable format. In some embodiments, the computer implemented methods and systems herein disclosed may be used in conjunction with either the Continuity of Care Record or the Continuity of Care Document standards.

The CCD is a joint effort of HL7 and ASTM to foster interoperability of clinical data to allow physicians to send electronic medical information to other providers without loss of meaning, which should ultimately improve patient care. It passed balloting in February 2007 and is endorsed by the Healthcare Information Technology Standards Panel (HITSP) as the harmonized format for the exchange of clinical information, including patient demographics, medications, and allergies. The CCD is a CDA implementation of ASTM's Continuity of Care Record (CCR). It is intended as an alternate implementation to the one specified in ASTM ADJE2369 for those institutions or organizations committed to implementation of the HL7 Clinical Document Architecture. The CCD represents a complete implementation of CCR, combining the best of HL7 technologies with the richness of CCR's clinical data representation, and does not disrupt the existing data flows in payer, provider, or pharmacy organizations. The CCD is an XML-based standard that specifies the structure and encoding of a patient summary clinical document. It provides a snapshot in time, constraining a summary of the pertinent clinical, demographic, and administrative data for a specific patient. From its inception, CDA has supported the ability to represent professional society recommendations, national clinical practice guidelines, standardized data sets, etc.

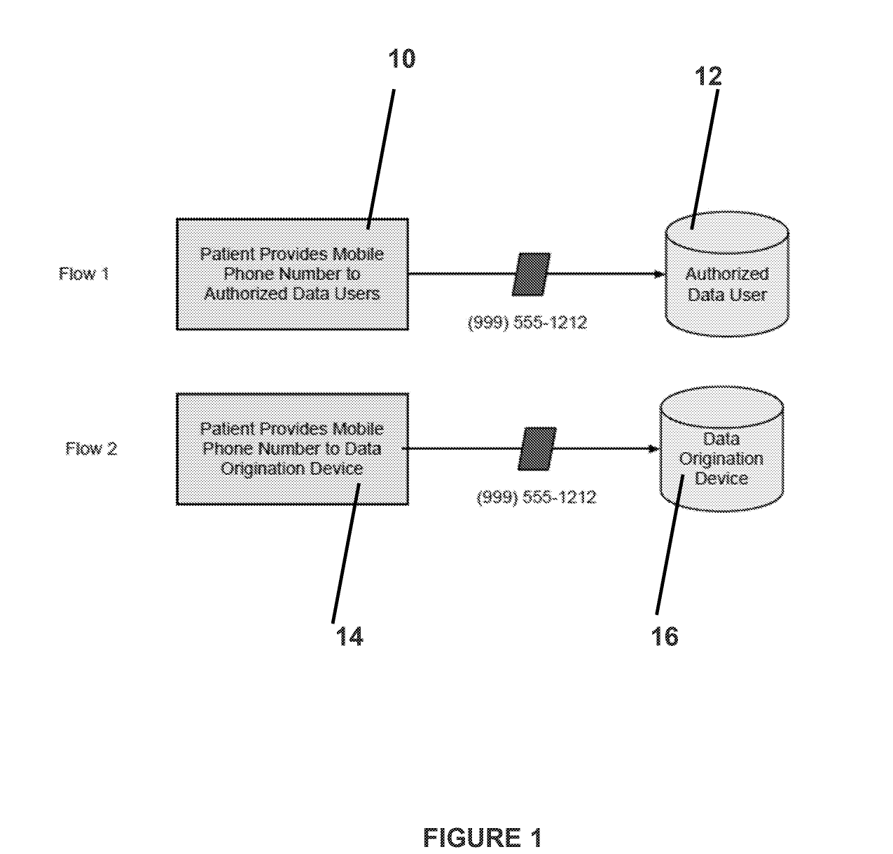

FIG. 1 is a flow diagram that illustrates an example of how the patient submits a mobile phone number to both the data origination device and authorized data users according to the invention. As shown on FIG. 1, in Flow 1 the patient provides his mobile phone number 10 to one or more authorized data users 12; in Flow 2 a patient provides his mobile phone number 12 to a data origination service 16. Thus, data created in the data origination device is uniquely identified with the patient and, when sent to the authorized data user, is also uniquely identified with the patient.

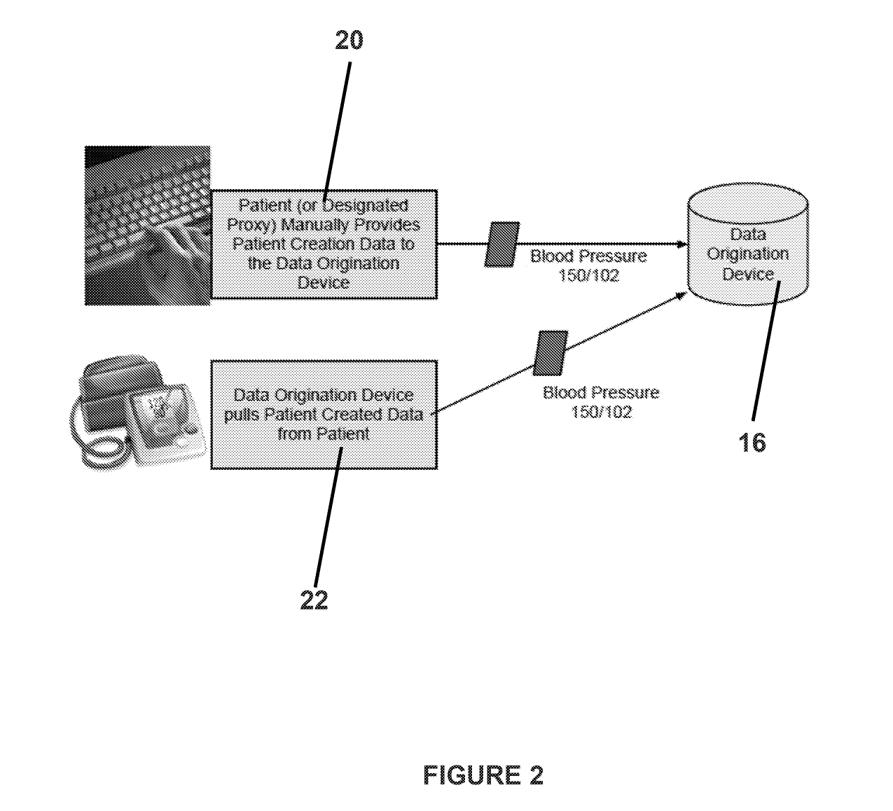

FIG. 2 is a block schematic diagram that illustrates an example of patient created data being inputted 20 into the data origination device or being read 22 from the patient's body by the data origination device 16 according to the invention. In connection with FIG. 2, the computer implemented methods and systems as described herein may be used in a non limiting fashion as follows:

First, the patient may register with one or more data origination devices and one or more authorized data users with such registration including the conveyance by the patient or his designee of the patient's mobile phone number.

Next, either the patient enters patient created data into the data origination device, for example evening blood pressure readings every day, or the data origination device reads the data directly from the patient's body, for example a blood pressure device with the capability to transmit evening blood pressure readings without manual data entry by the patient.

Next, the data are transmitted to the authorized data user's EHR or the authorized data user's computer, server, or data network, as part of a message or by other means over a data network. The message transmission may pass through a variety of data intermediaries who route the message to the appropriate authorized data user's EHR by the use of a data user's ID, for example a National Provider Identifier (NPI).

Next, when the message arrives at the correct authorized data user's computer, server, or data network that houses or supports an EHR, it is opened and the mobile phone number of the patient, or derivative thereof, contained in the message is used in part or in whole to file the patient created data properly in the correct patient record in an EHR among the multitude of patient records located within an EHR database or databases.

In an embodiment of the invention, this routing mechanism can be thought of by analogy to the delivery of a letter within a sealed envelope sent through the U.S. Mail. In the example above, the patient's telephone number, or derivative or transformation thereof, is used to route the message to a proper recipient, in this case the patient's electronic health records in one or more EHR, just as the name portion of an address on a U.S. Mail envelope is used to identify the recipient of the letter; the routing to the EHR is analogous to the street address used to deliver a letter or letters; and the message itself is analogous to the content of the letter. In current usage, a letter may be delivered to an address where it may be opened, wrongly perhaps, by anyone at that address because many people may live at that address and personal delivery to the correct person, while available as a special service of the USPS, for example, is rarely convenient. Such wrongful interception of a message is not possible with the invention herein because the message can only be routed to specific locations within one or more desired destinations, as specified by the patient's mobile phone number or derivative or transformation thereof. Again, the use of a mobile phone number as part of the technique taught herein solves the problem of providing a unique and collision-less identifier, while protecting private information of a patient, such as the patient's SSN, for public access. The invention thus provides an information deposit mechanism that may be used universally to enter patient health related information from many sources into patient records in many EHR databases. Neither the source of the patient health related information, such as a patient monitoring device, nor the destination for such patient health related information need provide any unique identifiers other than the patient's mobile phone number or derivatives or transformations thereof.

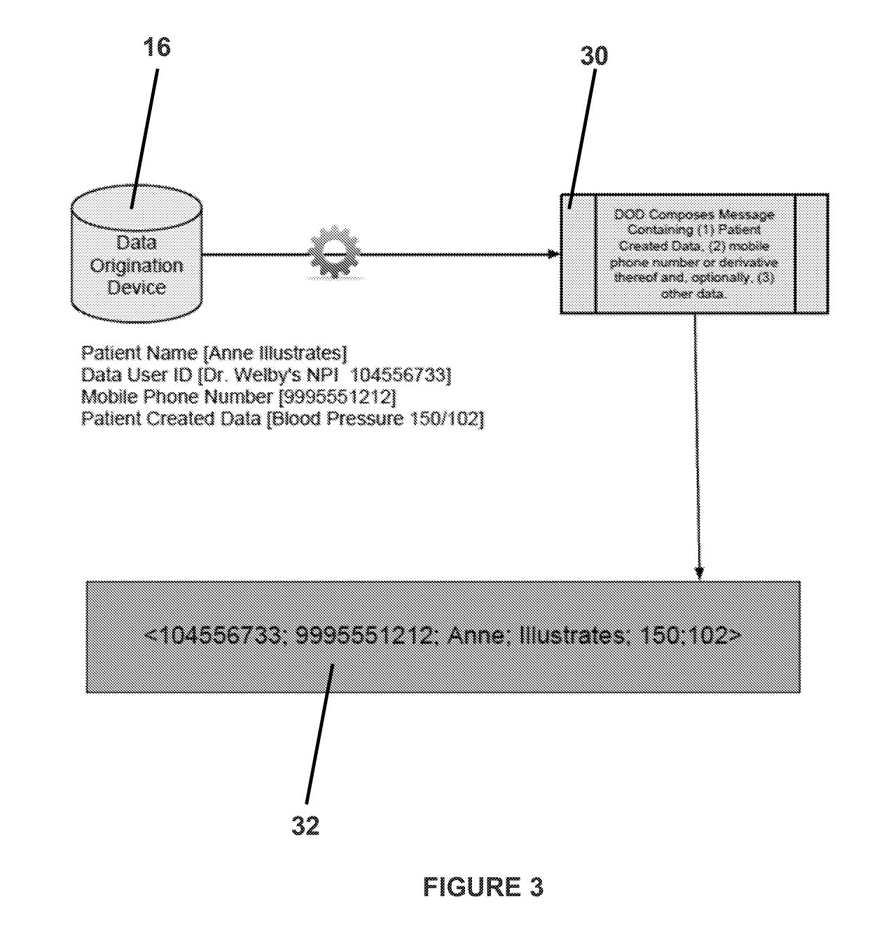

FIG. 3 is a block schematic diagram that illustrates an example of how a message containing the patient created data is created using the patient's mobile phone number according to the invention. The illustration uses a fictitious patient (Anne), two fictitious physicians (Dr. Welby and Dr. Goodgland) and a fictitious software application (iSugar).

A diabetic patient (let's call her Anne) wishes to convey her blood glucose levels twice a day (at waking in the morning and in the evening) to her primary care physician (“PCP”) named Dr. Welby and her specialist physician, an endocrinologist, named Dr. Goodgland. Each physician uses an EHR in his practice of medicine, but the PCP uses different EHR software than the endocrinologist. Anne would like to use the iSugar application that runs on her Apple iPhone to enter her blood glucose levels twice a day after she measures them with her glucometer. iSugar allows patients to enter health information about themselves and transmit it to authorized data users.

To start the process, Anne conveys her mobile phone number to the office staff of both physicians who attach this data to Anne's profile in their respective EHRs.

Next, Anne registers with her iSugar application. To register, Anne may enter her profile information which includes her name and mobile phone number and perhaps other data. If the software application can read her mobile phone number automatically, she may not have to enter it manually as part of registration.

After registration, Anne looks up Dr. Welby and Dr. Goodgland from a directory of data users and authorizes both physicians as data users for her health data either via iSugar or via some other authorization process. The directory of data users may be accessible via iSugar's application but may alternatively be accessible elsewhere. Depending upon the location of the directory and authorization process, Anne may need to designate iSugar as the software she is using to store and transmit her health data. Note that the specifics about registration and authorization are outside the scope of the invention and are only offered to support an illustration of how the invention works.

Upon successful registration, Anne is ready to begin using iSugar to convey her blood glucose levels to the two physicians. The next morning (October 15th), she measures her blood glucose with the data origination device 16 (FIG. 3) and reads a level of 115. She turns on her iPhone, opens the iSugar application and enters the value of 115.

Once the data have been entered by Anne into iSugar, the iSugar application composes 30 (FIG. 3) one or more messages and sends them to an iSugar server or a data network or other systems. For example, the messages 32 (FIG. 3) about Anne's blood glucose reading include Anne's mobile phone number or some derivative or transformation thereof, the value of her blood glucose reading, and identifiers of the receiving data users or their EHRs. By way of example, these identifiers might be the National Provider Identifiers (“NPI”) of the receiving physicians. By further way of example, other information may be included in the message including, but not limited to, date and time of transmission, time and date of the blood glucose reading as reported by Anne, Anne's name and other data to which iSugar has access and has deemed necessary.

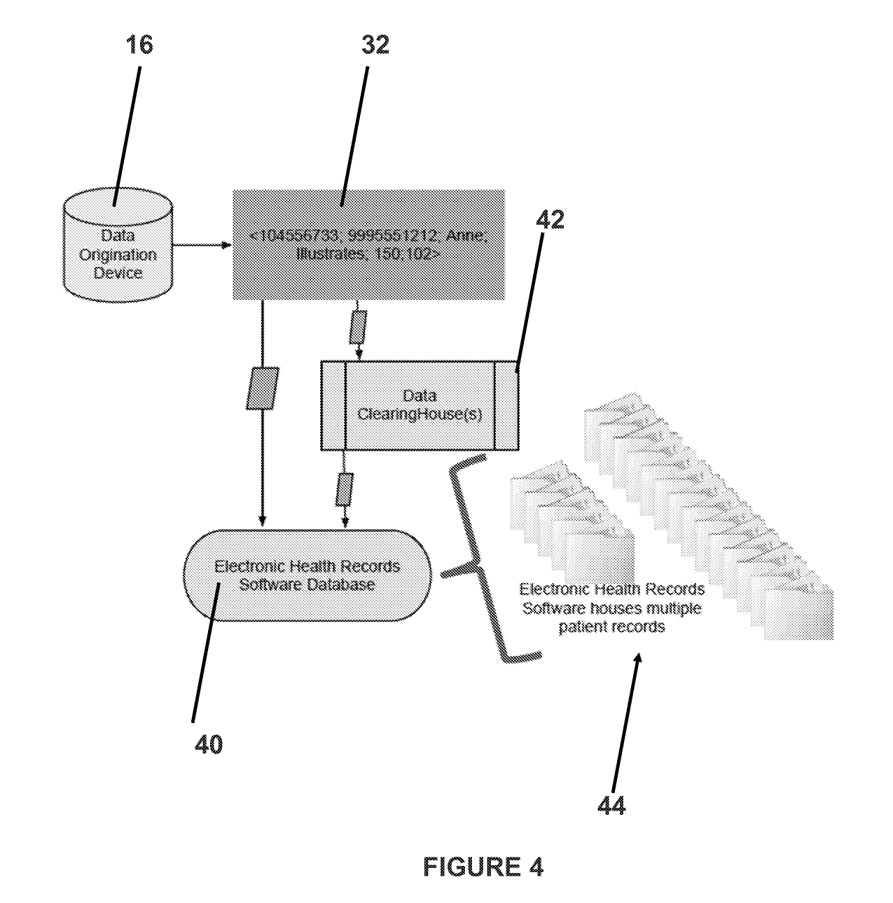

FIG. 4 is a block schematic diagram that illustrates an example of some of the pathways the message containing the patient created data might take as it travels from the data origination device to the electronic health records software and/or computers of the authorized data users according to the invention. As shown in FIG. 4, the identifiers of the physicians' EHRs are used by iSugar, a data network, or data networks, or other systems to route the message to the correct EHR 44 in an EHR database 40, such as via a data clearing house 42. In a similar way, a portion of an address on an envelope sent through the U.S. Mail represents a method of routing. The Street Number, Street Name, City, State and zip code elements of the envelope's address are used to route the letter to the correct mailstop that houses the intended recipient.

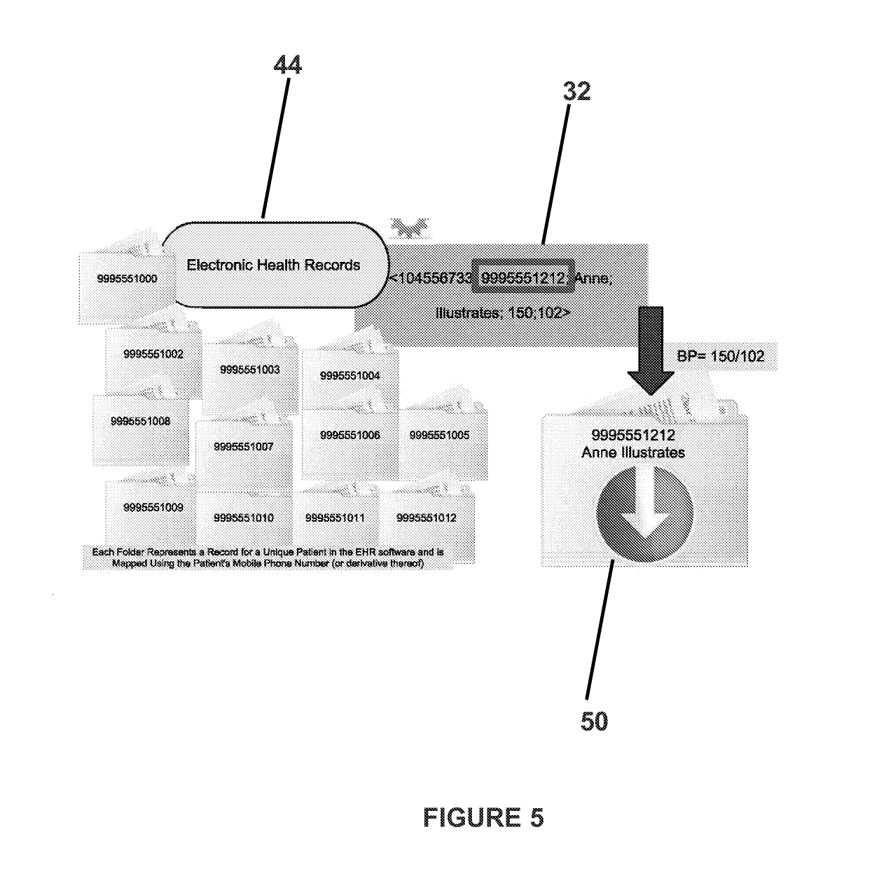

FIG. 5 is a block schematic diagram that illustrates an example of how the patient's mobile phone number may be used to identify the correct patient record in the data user's EHR software and as a result the patient created data is written to the correct patient record according to the invention. Once the message reaches the correct EHR 44, it is mapped to the correct electronic patient record 50 using the patient's mobile phone number or a derivative thereof 32, perhaps combined with other data. In a similar way, a portion of an address on an envelope sent through the U.S. Mail represents a method of routing; and a portion of an email address in the form “yourname@yourdomain.com” represents a method of mapping. The name element of the address on the envelope sent through the U.S. Mail is used to map the message to the correct individual once it arrives at the correct mailstop; and the “yourname” element of the email address is used to map the message to the correct individual once it arrives at the correct email server.

By adoption of the invention, patients can convey and data users can capture patient created data accurately, efficiently, and in a timely manner so that data users may better coordinate care for patients and provide them with better health outcomes at a lower cost to the health care system than might otherwise be achieved without the invention.

### Computer Implementation

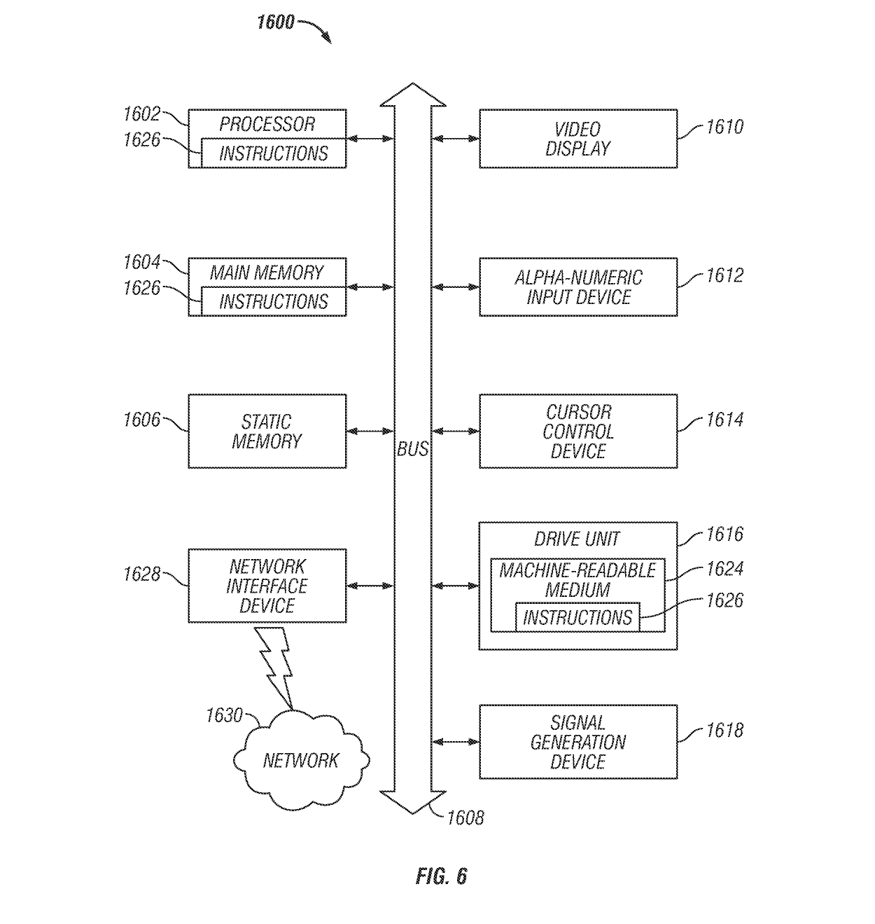

FIG. 6 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616, if included, includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1-21. (canceled)

22. A computer implemented method for allowing information to be properly routed to and organized in an electronic health record (EHR) database for any of managing, assessing, diagnosing, and recording information relating to a patient's health or health care, comprising:
receiving said patient's mobile phone number;
establishing a patient identity component based on said patient's mobile phone number, wherein said patient identity component is at least a parent ranking element in a hierarchy of personal information that is used for identifying said patient;
receiving, via a sensor or a human interface device, patient created health related data;
combining said patient identity component, patient created health related data and an authorized data user identifier to create a data origination device message; and
transmitting, within a secure wrapper, said data origination device message to at least one of a data user proxy, health related data repository, data clearinghouse, EHR and an authorized data user such that said data origination device message is available for routing to and storage in an EHR database as at least part of said patient's record, wherein the record is accessible to one or more of said data user proxy, health related data repository, data clearinghouse, EHR and an authorized data user.

23. The method of claim 22, further comprising:
obtaining registration information that includes said patient's mobile phone number; and
transmitting the registration information to one or more EHRs associated with said authorized data user.

24. The method of claim 22, wherein the transmitting of the registration information is conveyed in response to receiving a request for the registration information.

25. The method of claim 22, further comprising formatting said data origination device message in accordance with at least one of Continuity of Care Record (CCR), Continuity of Care Document (CCD), ELINCS, Health Level 7 (HL7), and XML standards, allowing said message to be written to a correct patient record in one or more EHRs.

26. The method of claim 22, wherein said establishing of a patient identity component further comprises using said patient's mobile phone number or any derivative or transformation thereof.

27. The method of claim 22, further comprising:
receiving patient related data which is used for correct routing of the data origination device message to patient records in one or more EHRs.

28. The method of claim 22, wherein the authorized data user identifier comprises a National Provider Identifier (NPI) or a derivative or transformation thereof.

29. A nontransitory, computer-readable storage medium storing computer-executable instructions that allows information to be properly routed to and organized in an electronic health record (EHR) database for any of managing, assessing, diagnosing, and recording information relating to a patient's health or health care, said instructions comprising:
an instruction to receive said patient's mobile phone number;
instructions to establish a patient identity component based upon said patient's mobile phone number, wherein said patient identity component is at least a parent ranking element in a hierarchy of personal information that is used for identifying said patient;
an instruction to receive, via a sensor or a human interface device, patient created health related data from said patient;
an instruction to combine said patient identity component, patient created health related data and an authorized data user identifier to create a data origination device message; and
an instruction to transmit, within a secure wrapper, said data origination device message to at least one of a data user proxy, health related data repository, data clearinghouse, EHR and an authorized data user such that said data origination device message is available for routing to and storage in an EHR database as at least part of said patient's record, wherein the record is accessible to one or more of said data user proxy, health related data repository, data clearinghouse, EHR and an authorized data user.

30. The computer-readable storage medium of claim 29, wherein said instructions further comprise:
an instruction to receive registration information that includes said patient's mobile phone number; and
an instruction to transmit the registration information to one or more EHRs associated with said authorized data user.

31. The computer-readable storage medium of claim 30, further comprising an instruction to transmit the registration information in response to receiving a request for the registration information.

32. The computer-readable storage medium of claim 29, wherein said instructions further comprise an instruction to format said data origination device message in accordance with either the Continuity of Care Record (CCR), the Continuity of Care Document (CCD), ELINCS, Health Level 7 (HL7), or XML standards, allowing said message to be written to a correct patient record in one or more EHRs.

33. The computer-readable storage medium of claim 29, wherein said instruction to establish a unique patient identity component further comprises an instruction to use said patient's mobile phone number or any derivative or transformation thereof.

34. The computer-readable storage medium of claim 29, wherein the instructions further comprise an instruction to receive patient related data that aids in the correct routing of the data origination device message to patient records in one or more EHRs.

35. The computer-readable storage medium of claim 29, wherein the authorized data user identifier comprises a National Provider Identifier (NPI) or a derivative or transformation thereof.

36. A system for transmitting and routing patient created health related data to at least one of a data user proxy, health related data repository, data clearinghouse, EHR and an authorized data user, the system comprising:
a communication network;
one or more data origination devices, each data origination device having a processor, and memory coupled to the processor; and
one or more server computers communicatively coupled to the communication network and the one or more data origination devices;
one or more data origination devices having an application stored thereon, the application configured or programmed to receive inputs at the processor from a patient including said patient identity component that is established based upon said patient's mobile phone number, wherein said patient identity component is at least a parent ranking element in a hierarchy of personal information that is used for identifying said patient, and patient created health related data and an authorized data user identifier;
wherein the application is configured or programmed to cause the processor to automatically or upon manual input, to construct a data origination device message combining said patient identity component, patient created health related data and an authorized data user identifier executing on the data origination device;
the application configured or programmed to cause the processor automatically or upon manual input to transmit the data origination device message to a communications network to at least one or more server computers such that said data origination device message is available for routing to and storage in an EHR database as at least part of said patient's record in said EHR, wherein the record is accessible to one or more of said authorized data user, authorized data user proxy, health related data repository, data clearinghouse, and EHR.

37. The system of claim 36, further comprising:
said authorized data user using said patient's mobile phone number to send a message to said one or more data origination devices; and
said message facilitating said patient to complete a registration procedure between one or more said data origination devices associated with said patient and one or more EHRs associated with said data user subsequent to said patient's registration with said authorized data user.

38. The system of claim 36, wherein a patient identity component is established using a derivative or transformation of said patient's mobile phone number.

39. The system of claim 36, wherein said one or more data origination devices receives patient related data that is used for mapping patient created health data to correct patient record(s) in one or more EHRs.

40. The system of claim 36, wherein the authorized data user identifier comprises a National Provider Identifier (NPI) or a derivative or transformation thereof.

41. The system of claim 36, wherein the application is configured to format said data origination device message in accordance with at least one of Continuity of Care Record (CCR), Continuity of Care Document (CCD), ELINCS, Health Level 7 (HL7), and XML standards, allowing said message to be written to a correct patient record in one or more EHRs.
